(19) United States
(12) Patent Application Publication
(10) Pub. No.: US 2009/0096753 A1
(43) Pub. Date: Apr. 16, 2009

(54) Apparatus and Method for Changing On-Screen Image Position, and Navigation System Using the Same

(75) Inventor: Jong-Sup Lim, Gyeonggi-do (KR)

Correspondence Address: EDELL, SHAPIRO & FINNAN, LLC, 1901 RESEARCH BOULEVARD, SUITE 400, ROCKVILLE, MD, 20850, US

(73) Assignee: Hyundai Autonet, Gyeonggi-do (KR)

(21) Appl. No.: 12/118,183

(22) Filed: May 9, 2008

(30) Foreign Application Priority Data
Oct. 16, 2007 (KR) 10-2007-0103872

(51) Int. Cl. G06F 3/041; G01C 21/36

(52) U.S. Cl. 345/173; 345/657; 345/667; 701/212

(57) ABSTRACT

Provided are an apparatus and method for changing a position of an image on a screen of an image display device, such as a map provided by a navigation system or mobile phone and a broadcast program played back by a television receiver, allowing the image to be reduced, enlarged, rotated, etc. through touching the on-screen image, and to a navigation system using the apparatus and method. The apparatus includes a display, a touch sensor, and a controller. The display displays an image. The touch sensor senses touching of the image displayed on the display. The controller changes a position of the image displayed on the display in a touched direction sensed by the touch sensor. The touch sensor generates positional coordinates of a touched point of the image sensed by the touch sensor, and relays the generated positional coordinates to the controller.

### CROSS REFERENCE TO RELATED APPLICATIONS

This application claims priority under 35 U.S.C. §119 to Korean Patent Application No. 10-2007-103872, filed on Oct. 16, 2007, the entire contents of which are hereby incorporated by reference.

### FIELD OF THE INVENTION

The present disclosure relates to an apparatus and method for changing a position of an image on-screen, and more particularly, to an apparatus and method for changing a position of an image on a screen of an image display device, such as a map provided by a navigation system or mobile phone and a broadcast program played back by a television receiver, allowing the image to be reduced, enlarged, rotated, etc. through touching the on-screen image, and to a navigation system using the apparatus and method.

### BACKGROUND

The use of navigation systems by drivers of road-going vehicles for receiving positional data of travel routes has recently burgeoned. These navigation systems use positional coordinates of a vehicle, including longitudinal data, latitudinal data, and altitudinal data received from satellites to generate the position of the vehicle and display a map showing the vehicle's current geographical position and the route to a destination.

A map provided by a navigation system can be enlarged or reduced freely by a driver. A driver uses navigation system buttons in the vehicle to perform such enlarging or reducing of a map on a display. However, because buttons must be manipulated repeatedly in succession by the driver to perform enlarging or reducing of a map on-screen, these related art methods for enlarging and reducing maps divert the driver's attention from the road ahead while driving, and thus pose a serious safety risk.

Also, because maps provided by navigation systems may only be enlarged and reduced and cannot be rotated, a driver is unable to position and view a map in a desired direction.

### SUMMARY

Therefore, an object of the present invention is to provide an apparatus and method for changing a position of an image on a screen of an image display device, such as a map provided by a navigation system or mobile phone and a broadcast program played back by a television receiver, allowing the image to be reduced, enlarged, rotated, etc. through touching the on-screen image, and a navigation system using the apparatus and method.

Another object of the present invention is to provide an apparatus and method for changing a position of an image on a screen of an image display device, such as a map provided by a navigation system or mobile phone and a broadcast program played back by a television receiver, allowing the image to be reduced, enlarged, rotated, etc. through touching the on-screen image, and a navigation system using the apparatus and method, to allow a user to easily change the on-screen size or position of an image.

A further object of the present invention is to provide a navigation system and a map position changing method thereof that allow a map with a vehicle's positional data displayed on a screen to be reduced, enlarged, or rotated by touching the map, to thus allow the driver to easily change the position of the map while driving.

To achieve these and other advantages and in accordance with the purpose(s) of the present invention as embodied and broadly described herein, an apparatus for changing on-screen image position in accordance with an aspect of the present invention includes: a display for displaying an image; a touch sensor for sensing touching of the image displayed on the display; and a controller for changing a position of the image displayed on the display in a touched direction sensed by the touch sensor, wherein the touch sensor generates positional coordinates of a touched point of the image sensed by the touch sensor, and relays the generated positional coordinates to the controller.

To achieve these and other advantages and in accordance with the purpose(s) of the present invention, a method for changing on-screen image position in accordance with another aspect of the present invention includes: displaying an image; sensing a touching of the displayed image, and generating positional coordinates of a touched point; and changing a position of the displayed image in a sensed touched direction.

To achieve these and other advantages and in accordance with the purpose(s) of the present invention, a navigation system in accordance with another aspect of the present invention includes: a navigation receiver for receiving positional data from a satellite, and determining a current position of a vehicle from the received positional data; a display for displaying a map showing a direction of travel of the vehicle; a touch sensor for sensing touching of the map displayed on the display; a storage for storing map data; and a controller for displaying the position of the vehicle determined by the navigation receiver on the map stored in the storage, and changing a position of the map displayed on the display in a touched direction sensed by the touch sensor, wherein the touch sensor generates positional coordinates of a touched point of the map sensed by the touch sensor, and relays the generated positional coordinates to the controller.

To achieve these and other advantages and in accordance with the purpose(s) of the present invention, a method for changing on-screen map position in a navigation system in accordance with another aspect of the present invention includes: receiving positional data from a satellite, and determining a current position of a vehicle from the received positional data; displaying a predetermined map showing the position of the vehicle thereon; sensing touching of the displayed map, and generating positional coordinates of a touched point; and changing a position of the displayed map in a sensed touched direction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a configurative block diagram of an apparatus for changing an on-screen image position according to an embodiment of the present invention;

FIG. 2 is a flowchart of a method for changing an on-screen image position according to another embodiment of the present invention;

FIGS. 3A and 3B are exemplary diagrams showing touch directions for rotating an on-screen image according to further embodiments of the present invention;

FIGS. 4A and 4B are exemplary diagrams showing touch directions for reducing an on-screen image according to still further embodiments of the present invention;

FIGS. 5A and 5B are exemplary diagrams showing touch directions for enlarging an on-screen image according to even further embodiments of the present invention; and

FIG. 6 is a configurative block diagram of a navigation system capable of changing an on-screen image position by touch according to a yet further embodiment of the present invention.

### DETAILED DESCRIPTION

Hereinafter, specific embodiments will be described in detail with reference to the accompanying drawings.

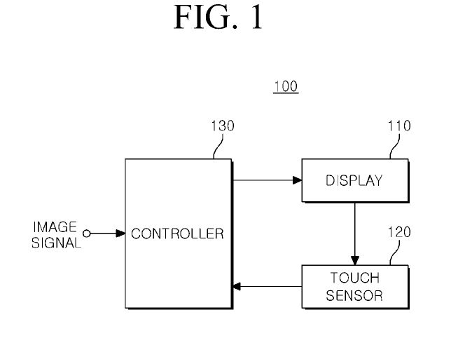

FIG. 1 is a configurative block diagram of an apparatus for changing an on-screen image position according to an embodiment of the present invention.

Referring to FIG. 1, an apparatus 100 for changing an on-screen image position according to the present invention includes a display 110 for displaying images, a touch sensor 120 for sensing touching of an image displayed on the display 110, and a controller 130 for repositioning an image on the display 110 according to the touching sensed by the touch sensor 120.

The display 110 displays an image transferred from the controller 130, and in particular, enlarges, reduces, or rotates an image displayed on the display 110 through the controller 130.

The touch sensor 120 generates the positions of points of an image displayed on the display 110 that are touched by a user, and relays the calculations to the controller 130.

The controller 130 displays an input image signal on the display 110, and enlarges, reduces, or rotates the image according to a touched direction on the display 110 when the touch sensor 120 senses positional coordinates of points touched by a user. The enlarging, reducing, or rotating of the image is performed when two or more points are touched; otherwise, a scroll is displayed at a single point that is touched.

An image enlarged, reduced, or rotated in a touched direction may be a map indicating a vehicle's position, a document, a photograph, etc.

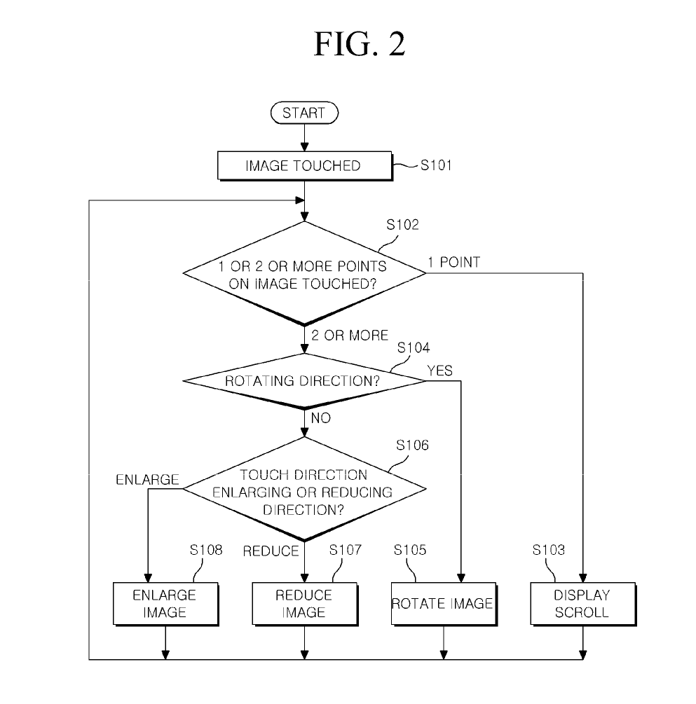

Referring to the flowchart of FIG. 2, a detailed description of the operation of an apparatus for changing the position of an on-screen image configured as above will be provided.

FIG. 2 is a flowchart of a method for changing an on-screen image position according to another embodiment of the present invention.

Referring to FIG. 2, with an image displayed on the display 110, when a user touches the displayed image in operation S101, and the controller 130 determines in operation S102 if the touch sensor 120 has sensed whether 1 or 2 or more points of the image have been touched. If it is determined that only 1 point has been touched, the controller 130 interprets this as a command to display a scroll at the touched point, and displays a scroll at that point in operation S103.

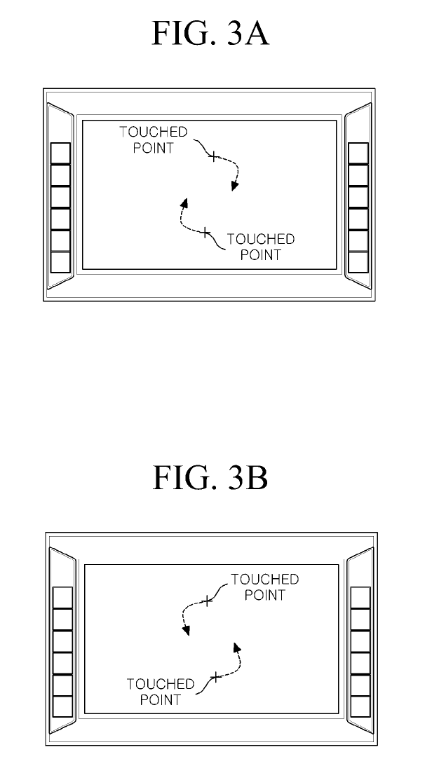

If it is determined that 2 or more points have been touched, the controller 130 determines in operation S104 whether the touched points sensed by the touch sensor 120 have been moved clockwise (as shown in FIG. 3A) or counterclockwise (as shown in FIG. 3B). If the movement is determined to be a rotation, the controller 130 rotates the image displayed on the display 110 clockwise (as shown in FIG. 3A) or counterclockwise (as shown in FIG. 3B) in operation S105.

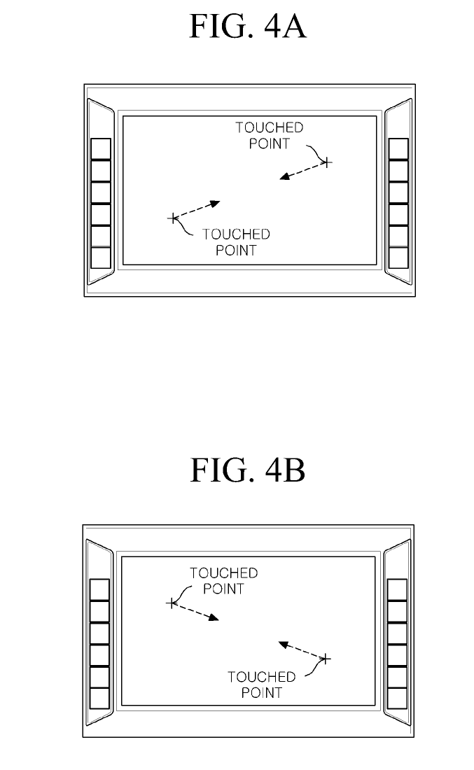

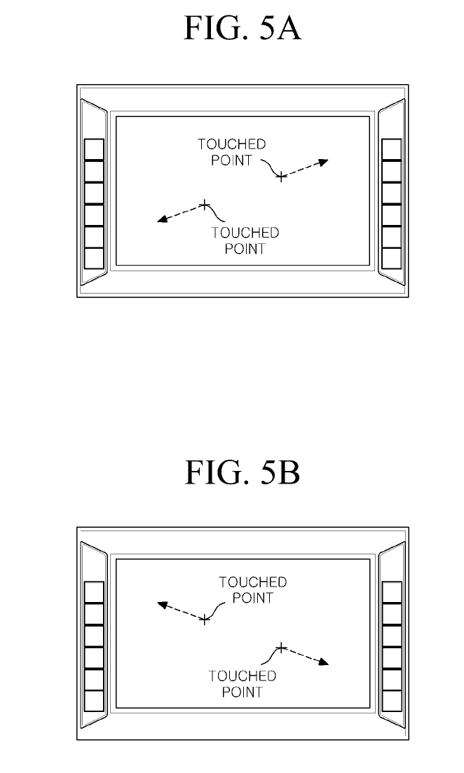

If it is determined in operation S104 that the movement was not a rotation, the controller 130 determines in operation S106 if the movement from the positions sensed by the touch sensor 120 was an inward movement (as shown in FIGS. 4A and 4B) for reduction or an outward movement (as shown in FIGS. 5A and 5B) for enlargement. If a reduction command is determined, the controller 130 reduces the image displayed on the display 110 in a direction such as those in FIGS. 4A and 4B in operation S107.

If it is determined in operation S106 that an enlarging command has been entered, the controller 130 enlarges the image displayed on the display 110 in an enlarging direction such as those shown in FIGS. 5A and 5B in operation S108.

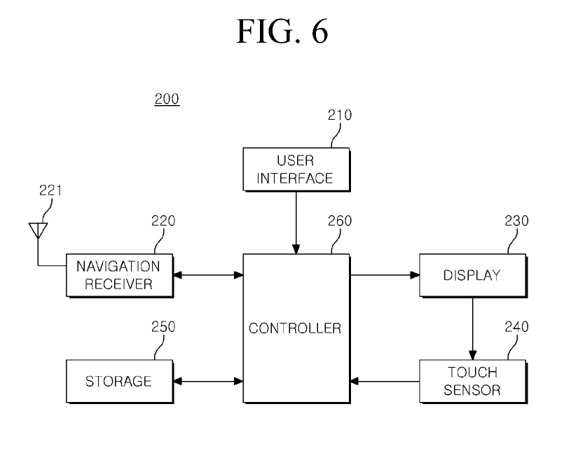

FIG. 6 is a configurative block diagram of a navigation system capable of changing an on-screen image position by touch according to a yet further embodiment of the present invention.

Referring to FIG. 6, a navigation system 200 according to the present invention includes a user interface 210 for a user to input commands for receiving vehicle position data, a navigation receiver 220 that receives positional data from satellites to determine the current position of the vehicle based on the received positional data, a display 230 displaying a map showing the vehicle's position and direction of travel, a touch sensor 240 for sensing touching of the map displayed on the display 230, a storage 250 for storing map and other data, and a controller 260 that shows the position of the vehicle detected by the navigation receiver 220 on a map stored in the storage 250 and displayed on the display 230, and changes the position of the map displayed the display 230 in a touched direction sensed by the touch sensor 240.

The user interface 210 may be embodied in a button or touch-screen configuration. Generally, in order to minimize the space they occupy when installed, most navigation systems employ a user interface 210 with a touch-screen display 230. Remote controllers are also employed to remotely input user commands when using navigation systems. While a user conventionally inputs data on a destination for a route to take through the user interface 210, the user may alternately use the user interface 210 to select digital multimedia broadcasting (DMB), TV, and radio channels and play back MPEG-1 audio layer 3 (MP3) files.

The navigation receiver 220 uses an antenna or other means to receive positional data of a vehicle including latitude, longitude, and altitude from satellites, and uses the received positional data to determine and output the current position of the vehicle through the controller 260.

The display 230 displays a map transferred by the controller 260, and in particular, enlarges, reduces, or rotates the map displayed on the display 230 via the controller 260.

The touch sensor 240 generates positional coordinates of points of the map displayed on the display 230 that are touched by a user, and relays the data to the controller 260.

The storage 250 may be a memory device such as an electrically erasable programmable read-only memory (EEPROM), NAND and other types of flash memory, etc. The storage 250 stores map data, a system operation firmware program, etc. In particular, the storage 250 may be configured as a built-in memory or as a removable memory such as a secure digital (SD) card, a multimedia card (MMC), and a universal serial bus (USB) memory stick.

The controller 260 displays the position of the vehicle received by the navigation receiver 220 on a map stored in the storage 250 on the display 230, and moves the on-screen position of the map in a touched direction as described below.

When a user touches only one point on a map displayed on the display 230, the controller 260 determines that this is a command to display a scroll at the touched position, and displays a scroll at the touched point.

When a user touches at least two points on the map displayed on the display 230, and moves clockwise from the touched points (as in FIG. 3A) or counterclockwise from the touched points (as in FIG. 3B), the controller 260 rotates the map displayed on the display 230 in the touched clockwise or counterclockwise direction.

When a user touches at least two points on a map displayed on the display 230 and moves inward from the touched points in a reducing direction, as shown in FIGS. 4A and 4B, the controller 260 reduces the map displayed on the display 230 in the reducing direction in FIG. 4A or FIG. 4B.

When a user touches at least two points on a map displayed on the display 230 and moves outward from the touched points in an enlarging direction, as shown in FIGS. 5A and 5B, the controller 260 enlarges the map displayed on the display 230 in the enlarging direction in FIG. 5A or FIG. 5B.

The present invention configured as above is capable of changing a position of an image on a screen of an image display device, such as a map provided by a navigation system or mobile phone and a broadcast program played back by a television receiver, allowing the image to be reduced, enlarged, rotated, etc. through touching the on-screen image, to allow a user to easily change the on-screen size or position of an image to a desired size or position.

The present invention also allows a driver to easily change the position of a map provided by a navigation system while driving by reducing, enlarging, or rotating the map through touching the map.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. An apparatus for changing an on-screen image position, the apparatus comprising:
a display for displaying an image;
a touch sensor for sensing touching of the image displayed on the display; and
a controller for changing a position of the image displayed on the display in a touched direction sensed by the touch sensor,
wherein the touch sensor generates positional coordinates of a touched point of the image sensed by the touch sensor, and relays the generated positional coordinates to the controller.

2. The apparatus of claim 1, wherein when the touched point of the image is the only point touched, the controller displays a scroll at the touched point.

3. The apparatus of claim 1, wherein when at least two points are touched and the touched points are moved in a rotating direction, the controller rotates the displayed image in the rotating direction.

4. The apparatus of claim 1, wherein when at least two points are touched and the touched points are moved in a reducing direction, the controller reduces the displayed image in the reducing direction.

5. The apparatus of claim 1, wherein when at least two points are touched and the touched points are moved in an enlarging direction, the controller enlarges the displayed image in the enlarging direction.

6. A method of changing a position of an image on-screen, comprising:
displaying an image;
sensing a touching of the displayed image, and generating positional coordinates of a touched point; and
changing a position of the displayed image in a sensed touched direction.

7. The method of claim 6, wherein the changing of the position of the displayed image in the sensed touched direction comprises, when the touched point is the only point touched, displaying a scroll at the touched point.

8. The method of claim 6, wherein the changing of the position of the displayed image in the sensed touched direction comprises, when at least two points are touched and the touched points are moved in a rotating direction, rotating the displayed image in the rotating direction.

9. The method of claim 6, wherein the changing of the position of the displayed image in the sensed touched direction comprises, when at least two points are touched and the touched points are moved in a reducing direction, reducing the displayed image in the reducing direction.

10. The method of claim 6, wherein the changing of the position of the displayed image in the sensed touched direction comprises, when at least two points are touched and the touched points are moved in an enlarging direction, enlarging the displayed image in the enlarging direction.

11. A navigation system comprising:
a navigation receiver for receiving positional data from a satellite, and determining a current position of a vehicle from the received positional data;
a display for displaying a map showing a direction of travel of the vehicle;
a touch sensor for sensing touching of the map displayed on the display;
a storage for storing map data; and
a controller for displaying the position of the vehicle determined by the navigation receiver on the map stored in the storage, and changing a position of the map displayed on the display in a touched direction sensed by the touch sensor,
wherein the touch sensor generates positional coordinates of a touched point of the map sensed by the touch sensor, and relays the generated positional coordinates to the controller.

12. The navigation system of claim 11, wherein when the touched point is the only point touched, the controller displays a scroll at the touched point.

13. The navigation system of claim 11, wherein when at least two points are touched and the touched points are moved in a rotating direction, the controller rotates the displayed map in the rotating direction.

14. The navigation system of claim 11, wherein when at least two points are touched, and the touched points are moved in a reducing direction, the controller reduces the displayed map in the reducing direction.

15. The navigation system of claim 11, wherein when at least two points are touched, and the touched points are moved in an enlarging direction, the controller enlarges the displayed map in the enlarging direction.

16. A method of changing a position of a map in a navigation system, comprising:
receiving positional data from a satellite, and determining a current position of a vehicle from the received positional data;
displaying a predetermined map showing the position of the vehicle thereon;
sensing touching of the displayed map, and generating positional coordinates of a touched point; and
changing a position of the displayed map in a sensed touched direction.

17. The method of claim 16, wherein the changing of the position of the displayed map in the sensed touched direction comprises displaying a scroll at the touched point when the touched point is the only point touched.

18. The method of claim 16, wherein the changing of the position of the displayed map in the sensed touched direction comprises, when at least two points are touched and the touched points are moved in a rotating direction, rotating the displayed map in the rotating direction.

19. The method of claim 16, wherein the changing of the position of the displayed map in the sensed touched direction comprises, when at least two points are touched and the touched points are moved in a reducing direction, reducing the displayed map in the reducing direction.

20. The method of claim 16, wherein the changing of the position of the displayed map in the sensed touched direction comprises, when at least two points are touched and the touched points are moved in an enlarging direction, enlarging the displayed map in the enlarging direction.
